(19) United States
(12) Patent Application Publication
(10) Pub. No.: US 2019/0152415 A1
(43) Pub. Date: May 23, 2019

(54) IMPACT ENERGY ABSORBING APPARATUS

(71) Applicant: METAL INDUSTRIES RESEARCH&DEVELOPMENT CENTRE, KAOHSIUNG (TW)

(72) Inventors: PEI-CHUN TUNG, KAOHSIUNG (TW); DIAN-YONG LIN, KAOHSIUNG (TW); CHIN-KAI WANG, KAOHSIUNG (TW); LI-DE WANG, KAOHSIUNG (TW)

(21) Appl. No.: 16/195,940

(22) Filed: Nov. 20, 2018

(30) Foreign Application Priority Data
Nov. 21, 2017 (TW) 106140296

(51) Int. Cl. B60R 19/34; B60R 19/48

(52) U.S. Cl. CPC B60R 19/34; B60R 2019/005; B60R 19/48

(57) ABSTRACT

An impact energy absorbing apparatus includes: a base, an axial crush component, a top plate, and an energy transfer component. The base is fastened to a protected object, and a tapered hole is provided on a top surface of the base. A bottom end face of the metal hollow rod of the axial crush component is joined with the top surface of the base. The energy transfer component includes a force bearing plate and a guiding rod extending outwards, where the force bearing plate is superimposed on a top surface of the metal hollow rod, the guiding rod is inserted to a position corresponding to the tapered hole in the metal hollow rod, an outer diameter of the guiding rod is less than a greatest diameter of the tapered hole, an inner diameter of the guiding rod is greater than a smallest diameter of the tapered hole.

### BACKGROUND

### Technical Field

The present invention relates to an impact energy absorbing apparatus, and in particular, to an impact energy absorbing apparatus absorbing impact energy by using pipe compression and deformation of a guiding rod, to reduce slanting and deformation of a composition structure in combination with an energy transfer component assembly and an energy absorbing component assembly when an entire structure bears an impact.

### Related Art

Currently, there are many types of energy absorbing structures applied when vehicles collide and bear an impact, for example, a path-type energy absorbing unit 1 used in a vehicle collision and impact system disclosed in US patent document U.S. Pat. No. 6,231,095 B1, as shown in FIG. 1A and FIG. 1B. The path-type energy absorbing unit 1 may absorb impact energy and prevent or minimize damage of a vehicle framework track 14 under an impact. In a basic embodiment thereof, one end of a pipe 11 is open and welded at a hole 121 of an end plate 12. When the path-type energy absorbing unit 1 axially bears a load, the pipe 11 splits, peels off, and reverses to absorb most energy impact. A preferred path 13 in the pipe 11 stabilizes inner compression during this process to ensure a predetermined energy absorbing feature. Although the path-type energy absorbing unit 1 applied to the related art is a simple circular pipe structure and can be easily obtained, a deformation process thereof is in a stable force bearing mode, and grooves of the path-type energy absorbing unit 1 need to be provided (manufactured) longitudinally to help generate a stable tearing and peeling-off mode. This increases costs. Besides, a path 13 of the path-type energy absorbing unit requires pipe extension and eversion, and needs to be joined with a rigid board. Therefore, there is a risk that a joining point splits and becomes invalid under an impact.

In addition, U.S. Pat. No. 8,511,745 B2 discloses a vehicle collision structure for comprehensive energy absorbing. Components thereof include an inner portion and an outer portion of a track housing and a connected protruding portion. The protruding portion has a slope blocking a port of the track housing. When a pipe piece bears an impact, a circular inner wall of the track housing is compressed towards a radial direction of a chamber to deform by using the protruding portion and the slope. When both the pipe component and the track housing are made of aluminum, a static friction coefficient is between 1.05 and 1.35, and a dynamic friction coefficient is 1.4. When the pipe component is made of iron and the track housing is made of aluminum, a static friction coefficient is 0.61, and a dynamic friction coefficient is 0.47. The track housing in this patent is made of aluminum or aluminum alloy, and uses a hexagon or an octagon double-layer shared wall structure. The track housing in this patent is a hexagon or an octagon, and has a high-rigidity geometric appearance resisting bending, and quantities of inner chambers and radial ribs of the track housing and rib widths are important for structural deformation and energy absorption. However, the protruding portion and the slope of the sliding pipe component thereof cannot be formed easily geometrically, and manufacturing costs are increased. Besides, if the protruding portion of the sliding pipe component is excessively high, the pipe component cannot be pressed into the track housing, so that an exposed portion of the pipe component is axially overlapped and deforms in an impact process, and expected outline deformation of the track housing cannot be achieved.

Further, an assembly structure of an impact absorption apparatus in US patent case U.S. Pat. No. 4,272,114 is formed by two structures. An outer portion thereof is a box-shaped trapezoid molded sheet metal part and an inner pipe component, a bevel of a sub-element has several holes, and louver geometric shapes of punched folded edges are around the holes. When the assembly bears an impact, a collision prevention rod transfers energy of an impact force to a trapezoid box of the sub-element by using a rod component and a base for compression and deformation. Because the bevel of the sub-element has an appearance of a punched hole and a louver geometric shape for superimposing and deformation, the pipe moves towards a beam structure by using a bottom central hole of the sub-element. The appearance of the punched hole may be a C shape, an H shape, or a bone shape. There is a gap between geometries with punched folded edges on the bevel of the sub-element in this patent, to form a region with a relatively small structural cross-sectional area. When the structure bears an impact, this position first deforms. Quantities of inner chambers and radial ribs of the track housing and rib widths are important for structural deformation and energy absorption. However, after the punched folded edges of the sub-element are manufactured, split rift defects are easily generated around the holes, and there may be a disadvantage that impact energy absorption is discontinuous because the structure splits under an impact. Engineering of the punched folded edges may be completed before a folded trapezoid is formed. In this case, engineering of a trapezoid metal plate is uneasy, and a geometric appearance of the completed punched folded edges is easily damaged. If the punched folded edges are produced after forming of the trapezoid is completed, punching needs to be performed once both from the outside to the inside and from the inside to the outside, and molds, a manufacturing time, and costs need to be increased.

### SUMMARY

An objective of the present invention is to use pipe compression and deformation of a pipe material of an energy transfer component to absorb a part of energy, and use folding deformation of an energy absorbing component to absorb a part of energy during an impact, and maintain deformation of the energy transfer component and the energy absorbing component at a position of a central axis.

To achieve the foregoing objective, the present invention provides an impact energy absorbing apparatus, comprising: a base, fastened to a protected object, where a tapered hole having a wide top and a narrow bottom is provided on a top surface of the base; an axial crush component, comprising a metal hollow rod, where a bottom end face of the metal hollow rod is joined with the top surface of the base on a periphery of the tapered hole; and an energy transfer component, comprising a force bearing plate and a hollow guiding rod perpendicularly protruding outwards from the force bearing plate, where the force bearing plate is superimposed on a top end face of the metal hollow rod, the guiding rod is inserted to a position corresponding to the tapered hole in the metal hollow rod of the axial crush component, an outer diameter of the guiding rod is less than a greatest diameter of the tapered hole, an inner diameter of the guiding rod is greater than a smallest diameter of the tapered hole, and an end of the guiding rod abuts against a part of the tapered hole having the greatest diameter or passes through the tapered hole.

In an embodiment, a plurality of corrugated folding guiding portions is disposed in an encircling manner on a pipe wall between the top end face and the bottom end face of the metal hollow rod at intervals.

In an implementation, deformation resistance rigidity of the folding guiding portion of the axial crush component is less than those of the base and the guiding rod, and deformation resistance rigidity of the guiding rod is less than deformation resistance rigidity of the tapered hole of the base.

In an implementation, rigidity of the folding guiding portions of the axial crush component gradually decreases from a diameter of the bottom end face of the metal hollow rod to the top end face.

In an implementation, the metal hollow rod of the axial crush component is a tapered pipe having a greater diameter at the bottom end face than at the top end face.

In an implementation aspect, the bottom end face of the metal hollow rod of the axial crush component or the top end face of the metal hollow rod comprises an end plate portion extending inwards or outwards.

In an implementation aspect, the folding guiding portions are formed by pipe walls of the metal hollow rod protruding outwards or recessed inwards.

In an implementation aspect, the tapered hole of the base is formed by stamping a plate metal of the base or cutting a plate thickness of the base.

Features of the present invention are as follows: When an energy transfer component structure in the present invention is compressed by an impact force, the hollow guiding rod of the force bearing plate trends towards being inserted to the tapered hole of the base. The diameter of the guiding rod is guided by the greatest diameter of the tapered hole and is limited by the smallest diameter of the tapered hole, so that the hollow guiding rod generates a pipe compression effect, and a fixed deformation direction and a stable pipe compression energy absorption effect can be provided. In another aspect, the energy absorbing component jointly formed by a bottom plate and the axial crush component in the present invention also performs an energy absorbing function under an impact force. Still further, when the plurality of corrugated folding guiding portions is disposed in an encircling manner on the pipe wall between the top end face and the bottom end face of the metal hollow rod at intervals, the axial crush component folds based on a corrugated appearance of the folding guiding portions of the axial crush component. Further, when a longitudinal cross section thereof is in a geometric shape of a trapezoid, energy required in a folding process (that is, absorbed energy) can be increased. When an entire structure (including the energy transfer component and the energy absorbing component) bears an impact, after a compressed pipe of a pipe body deforms, the position still maintains at a central position, so that a composition structure does not slant or deform.

### BRIEF DESCRIPTION OF THE DRAWINGS

FIG. 1A and FIG. 1B are schematic diagrams of an impact energy absorbing system before and after impact absorption in the related art;

FIG. 2 is an exploded side view of an impact energy absorbing apparatus according to an embodiment of the present invention;

FIG. 3 is a side view of assembly of the impact energy absorbing apparatus in FIG. 2;

FIG. 4 is a side view of assembly of an impact energy absorbing apparatus according to another embodiment of the present invention; and

FIG. 5 is a schematic side view of structural deformation of the impact energy absorbing apparatus in FIG. 4 under an impact of an external force.

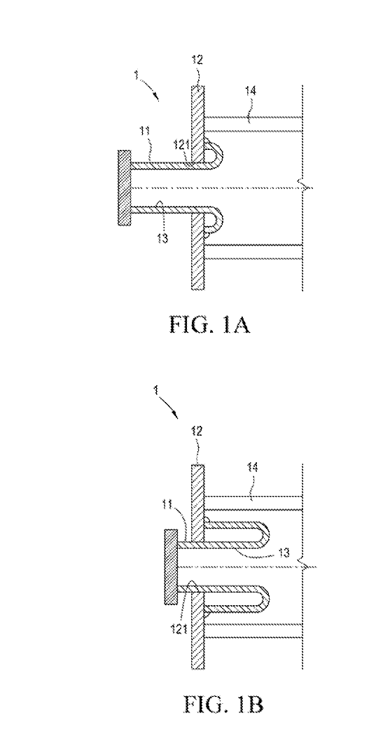

### DETAILED DESCRIPTION

The embodiments of the present invention are described below in detail with reference to drawings. The accompanying drawings are mainly simplified schematic diagrams, and only exemplarily show basic structures of the present invention. Therefore, the drawings show only components related to the present invention. Displayed components are not drawn based on quantities, shapes, sizes, proportions, and the like during implementation, and specifications and sizes thereof during actual implementation are optionally designed, and arrangement and forms of the components thereof may be more complex.

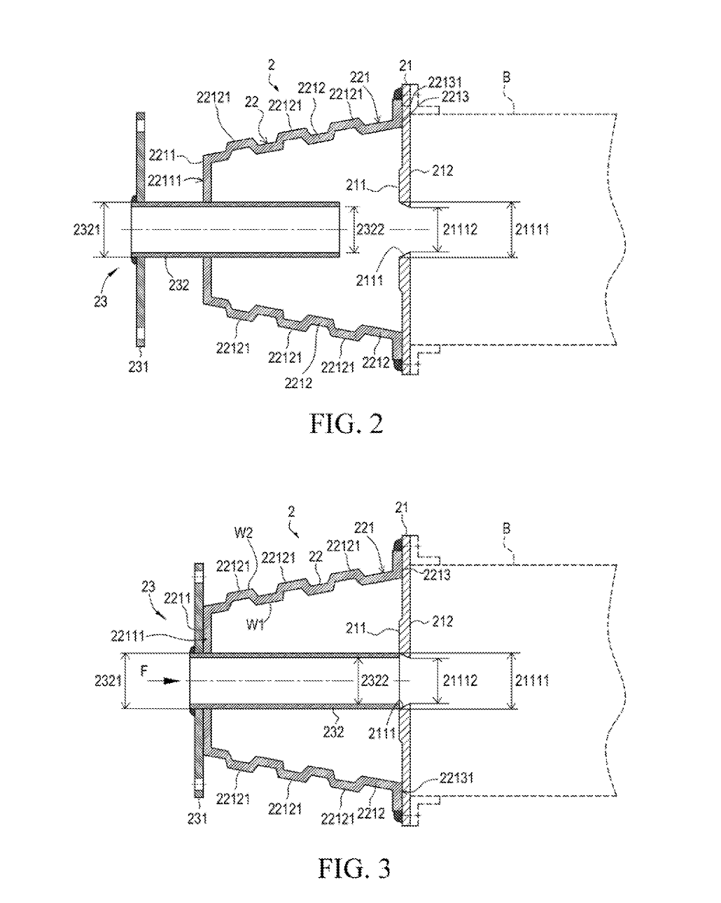

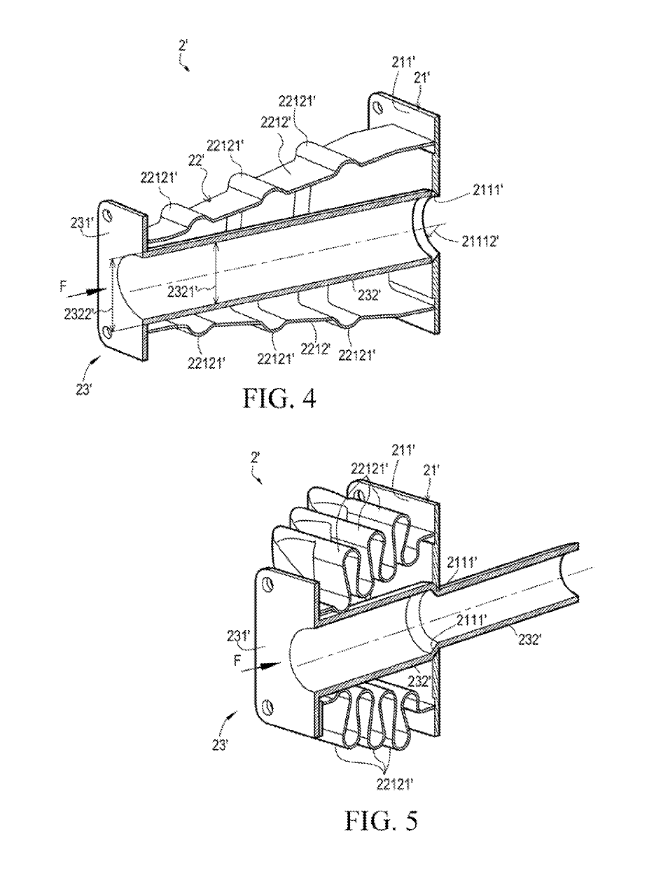

First, refer to FIG. 2, FIG. 3, FIG. 4, and FIG. 5. An impact energy absorbing apparatus 2 in an embodiment absorbs external impact energy by deformation, to reduce deformation and damage degrees of a protected object B. A structure of the impact energy absorbing apparatus 2 includes: a base 21, an axial crush component 22, and an energy transfer component 23. The base 21 may be fastened to the protected object B (usually an extending structure such as front, rear, and lateral beams outside a vehicle member cabin) by using a common thread-connected fastening technology. A tapered hole 2111 is provided on a top surface 211 of the base 21, a greatest diameter of the tapered hole 2111 is on a top surface of the tapered hole 2111, and a smallest diameter of the tapered hole 2111 may be provided on a bottom surface of the tapered hole 2111 or between the top surface and the bottom surface of the tapered hole 2111. The axial crush component 22 includes a metal hollow rod 221, and a bottom end face 2213 of the metal hollow rod 221 is joined with the top surface 211 of the base 21 on a periphery of the tapered hole 2111. The energy transfer component 23 includes a force bearing plate 231 and a hollow guiding rod 232 perpendicularly protruding outwards from the force bearing plate 231. The force bearing plate 231 is superimposed on a top end face 2211 of the metal hollow rod 221. The guiding rod 232 is inserted to a position corresponding to the tapered hole 2111 in the metal hollow rod 221 of the axial crush component 22, and the guiding rod 232 is a straight pipe. An outer diameter 2321 of the guiding rod 232 is less than a greatest diameter 21111 of the tapered hole 2111, an inner diameter 2322 of the guiding rod 232 is greater than a smallest diameter 21112 of the tapered hole 2111, and an end of the guiding rod 232 is at (or abuts against) a part of the tapered hole 2111 having the greatest diameter 21111 or passes through the tapered hole 2111. Particularly, in the foregoing components, deformation resistance rigidity of a folding guiding portion 22121 of the axial crush component 22 is less than those of the base 21 and the guiding rod 232, and deformation resistance rigidity of the guiding rod 232 is less than deformation resistance rigidity of the tapered hole 2111 of the base 21.

In configuration of the foregoing components, when the force bearing plate 231 of the energy transfer component 23 receives a pressing external impact force F, the force bearing plate 231 transfers the energy to the axial crush component 22, and the axial crush component 22 transfers the energy to the base 21. When the axial crush component 22 bears an impact of the axial external impact force F, because a bottom of the axial crush component 22 is fastened to the base 21 having relatively large rigidity, the external impact force F causes the folding guiding portion 22121 of a pipe wall 2212 of the metal hollow rod 221 of the axial crush component 22 to generate deformation, to absorb the external force transferred to the metal hollow rod 221. Besides, when the metal hollow rod 221 axially crushes and deforms, the guiding rod 232 of the energy transfer component 23 is inserted to a greatest aperture 21111 of the tapered hole 2111. In addition, because the outer diameter 2321 of the guiding rod 232 is less than the greatest diameter 21111 of the tapered hole 2111, and the inner diameter 2322 of the guiding rod 232 is greater than the smallest diameter 21112 of the tapered hole 2111, the guiding rod 232 generates pipe compression and deformation of the pipe diameter when passing through the tapered hole 2111, to provide a mechanism for absorbing the external impact force F.

As shown in FIG. 3, another design that can absorb the external impact force F is as follows: a plurality of folding guiding portions 22121 having relatively weak rigidity may be disposed in an encircling manner on the pipe wall 2212 between the top end face 2211 and the bottom end face 2213 of the metal hollow rod 221 at intervals. For example, a plurality of corrugated folding guiding portions 22121 is disposed in an encircling manner at intervals, so that rigidity of a trough W1 of the folding guiding portion 22121 is weaker than rigidity of a peak W2, and the trough W1 may first deform under an impact. Because a cross section of the trough W1 is relatively small and easily deforms, the trough W1 has weak rigidity (as shown in FIG. 4 and FIG. 5). Therefore, the metal hollow rod 221 may axially bend and crush when bearing an impact of the axial external impact force F of a central axis. In this way, the present invention is a design that provides a plurality of energy absorption structures without increasing space.

In addition, to be applied to different vehicle types, a material, a thickness, a shape, a length, and an angle of the axial crush component 22 in the present invention all may change, to conform to absorption of the force F.

It should be noted that in the foregoing embodiment, the force bearing plate 231 and the guiding rod 232 of the energy transfer component 23 are joined by means of welding, but are not limited to this joining method. For example, a method of joining by using glue is used. In addition, the metal hollow rod 221 in the foregoing embodiment is a circular cylinder, or may actually be a square cylinder, as shown in the following embodiment.

In an embodiment, rigidity of the folding guiding portions 22121 of the axial crush component 22 gradually decreases from the bottom end face 2213 of the metal hollow rod 221 to the top end face 2211, so that the folding guiding portion 22121 of the top end face 2211 may first generate deformation sequentially when the metal hollow rod 221 bears an axial impact, so that a deformation direction maintains at a center of the metal hollow rod 221.

In an embodiment, the metal hollow rod 221 of the axial crush component 22 is a tapered pipe having a greater diameter at the bottom end face 2213 than at the top end face 2211, to obtain a relatively large crushing deformation stroke.

In an embodiment, the bottom end face 2213 of the metal hollow rod 221 of the axial crush component 22 or the top the end face 2211 of the metal hollow rod 221 includes end plate portions (22111, 22131) extending towards an inner side or an outer side of the metal hollow rod 221, and the end plate portion 22131 joins with the base 21.

In an embodiment, the folding guiding portions 22121 are formed by corrugated pipe walls 2212 of the metal hollow rod 221 protruding outwards or recessed inwards.

In an embodiment, the tapered hole 211 of the base 21 is formed by stamping a plate metal of the base 21 or cutting a plate thickness of the base 21.

In an embodiment, the end of the guiding rod 232 of the energy transfer component 23 includes a guiding angle, so that the diameter 2321 of the end of the guiding rod 232 compresses inwards.

Refer to FIG. 4 and FIG. 5. A difference between an impact energy absorbing apparatus 2′ in this embodiment and the impact energy absorbing apparatus in the foregoing embodiment includes: a tapered hole 211′ of a base 21′ in this embodiment is formed by cutting a plate thickness of the base 21′; a metal hollow rod 221′ of an axial crush component 22′ in this embodiment is a square cylinder, and no end plate portion is designed on an end face of the metal hollow rod 221′ in this embodiment. In a structural combination thereof, the base 21′ is similarly fastened to a protected object, a guiding rod 232′ of an energy transfer component 23′ passes through the axial crush component 22′, and an end of the guiding rod 232′ is located at a tapered hole 2111′. When the energy transfer component 23′ transfers impact energy, the guiding rod 232′ is inserted to the tapered hole 2111′ and generates a pipe compression energy absorption effect. In addition, the axial crush component 22′ bears energy transferred by a force bearing plate 231′, so that a folding guiding portion 22121′ generates a folding deformation energy absorption effect.

The foregoing implementation forms only exemplarily describe the principle, the feature, and the effect of the present invention, instead of limiting the implementable scope of the present invention, and any person skilled in the art can modify and change the foregoing implementations without departing from the spirit and scope of the present invention. Any equivalent change and modification made based on the content disclosed in the present invention shall still be subject to the appended claims. Therefore, the right protection scope of the present invention shall be subject to the claims.

What is claimed is:

1. An impact energy absorbing apparatus, adapted to reduce an impact on a protected object, wherein a structure of the impact energy absorbing apparatus comprises at least:
a base, fastened to the protected object, wherein a tapered hole is provided on the base, and a greatest diameter of the tapered hole is on a top surface of the tapered hole;
an axial crush component, comprising a metal hollow rod, wherein a bottom end face of the metal hollow rod is joined with a top surface of the base on a periphery of the tapered hole; and
an energy transfer component, comprising a force bearing plate and a hollow guiding rod perpendicularly protruding outwards from the force bearing plate, wherein the force bearing plate is superimposed on a top end face of the metal hollow rod, the guiding rod is inserted to a position corresponding to the tapered hole in the metal hollow rod, an outer diameter of the guiding rod is less than a greatest diameter of the tapered hole, an inner diameter of the guiding rod is greater than a smallest diameter of the tapered hole, and an end of the guiding rod is at a part of the tapered hole having the greatest diameter or passes through the tapered hole.

2. The impact energy absorbing apparatus according to claim 1, wherein a plurality of corrugated folding guiding portions is disposed in an encircling manner on a pipe wall between the top end face and the bottom end face of the metal hollow rod at intervals.

3. The impact energy absorbing apparatus according to claim 2, wherein deformation resistance rigidity of the folding guiding portion of the axial crush component is less than those of the base and the guiding rod, and deformation resistance rigidity of the guiding rod is less than deformation resistance rigidity of the tapered hole of the base.

4. The impact energy absorbing apparatus according to claim 2, wherein rigidity of the folding guiding portions of the axial crush component gradually decreases from a diameter of the bottom end face of the metal hollow rod to the top end face.

5. The impact energy absorbing apparatus according to claim 1, wherein the metal hollow rod of the axial crush component is a tapered pipe having a greater diameter at the bottom end face than at the top end face.

6. The impact energy absorbing apparatus according to claim 1, wherein the bottom end face of the metal hollow rod of the axial crush component or the top end face of the metal hollow rod comprises an end plate portion extending inwards or outwards.

7. The impact energy absorbing apparatus according to claim 2, wherein the folding guiding portions are formed by pipe walls of the metal hollow rod protruding outwards or recessed inwards.

8. The impact energy absorbing apparatus according to claim 3, wherein the folding guiding portions are formed by pipe walls of the metal hollow rod protruding outwards or recessed inwards.

9. The impact energy absorbing apparatus according to claim 1, wherein the tapered hole of the base is formed by stamping a plate metal of the base.

10. The impact energy absorbing apparatus according to claim 1, wherein the tapered hole of the base is formed by cutting a plate thickness of the base.
